(19) United States
(12) Patent Application Publication
(10) Pub. No.: US 2007/0131359 A1
(43) Pub. Date: Jun. 14, 2007

(54) Screening device with a movable screen and an automating system

(75) Inventor: Roberto Brioschi, Borgoticino (IT)

Correspondence Address: SHELDON MAK ROSE & ANDERSON PC, 225 SOUTH LAKE AVENUE, 9TH FLOOR, PASADENA, CA, 91101, US

(73) Assignee: GIANUS S.P.A., MILANO (IT)

(21) Appl. No.: 10/595,537

(22) PCT Filed: Mar. 2, 2004
(86) PCT No.: PCT/IT04/00098

§ 371 Date: Apr. 26, 2006

(30) Foreign Application Priority Data
Nov. 27, 2003 (IT) TO2003 A 000951

(51) Int. Cl. E06B 9/56

(52) U.S. Cl. 160/310

(57) ABSTRACT

A screening device with a movable screen and an automating system (1) for mobile screens is disclosed comprising at least one mobile screen (2), guiding means for the movement of the mobile screen (2), compressing means for a fluid, channelling and controlling means for such fluid, internal magnetic elements connected to the mobile screen (2) and external magnetic elements (3) cooperating with the internal magnetic elements.

The present invention refers to an automating system for mobile screens that can slide and/or be wound, in particular for sun screens, curtains, mosquito nets, thermal screens both for home and for business buildings.

The need for automating sun screens and/or mosquito nets that can be wound is particularly felt in different situations, particularly when:
the screen is difficult to be reached, for example as in case of a very high window or a window placed in the stairs opening;
the screen is part of a wide group of similar pieces of equipment, that require to be driven in a centralised way, for example as in case of a widespread dimming system in an office building;
the screen must be frequently driven, for example by an operator with engaged hands, such as, for example, upon entry in a restaurant kitchen, a shop entry, the access for exchanging materials in a counter or a motorway fare payment (in order to limit the environment in which the operator is from getting cold);
the screen must be able to be quickly driven but with an external check, in order to avoid unwanted accesses, suchh as for example in case of access to a working area with moderate risks even only for the operator's hands, like an area with liquids-chips projection in an industrial process, an access area to a restaurant tunnel washing machine (replacing the plastic bands, that come in contact with dishes and surely are not sterile);
the opening to be protected is a door; in this case the technically more reliable solution is, as known, a vertical roller screen, however this solution becomes uncomfortable due to its drivability, forcing the user to bend himself for closing it and, in case the product has not a braked opening as known, also for opening it. The currently adopted solution is a screen with horizontal opening, that can be easily driven, but that however has the inconvenience of having a screen-containing outline on the ground, such outline obstructing the passage even if its sizes are reduced;
the brightness inside a room has to be quickly, repeatedly and silently adjusted in order not to cause disturbances, checking the sun screen position by coupling the automating system with a brightness sensor and a position sensor;
an energy saving system that is really working has to be realised. In order to realise such effect, both in case of heating, and, more importantly, in case of air conditioning, it is necessary to be able to place the screen outside. In case of heating, in fact, it is necessary to create a tepid air chamber between the window containing the heated room and the outside, in order to expose to the outside temperature a surface with intermediate temperature between the internal one and the temperature (in case of a typical cloudless winter evening with 3° K.) of the background radiation. Since the heat propagation by radiance is proportional to the square of the temperature difference between two sources of heat, it immediately results that breaking the heat propagation with an intermediate temperature is extremely efficient (10*10=100+10*10=100 is much lower than 20*20=400!). With an internal screen, instead, the screen temperature remains much nearer to the room one, highly reducing such effect. In case of conditioning, instead, the advantage of having an external screen is that once the visible radiation has managed to enter the room, it is converted in a infrared radiation on internal curtains with the effect of not being any more able to go out of the glass, that now has become opaque. This effect can be reduced by adopting an aluminised screen, but not completely solved. Therefore, in order to adopt an interesting saving strategy, it is necessary to be able to use an automatic, quick, silent and, above all, reliable external screen taking into account that, given its external placement, every type of maintenance will mostly be extremely uncomfortable. Moreover, being able to couple a presence sensor with an automation system, it would be possible to keep the dimming screens closed when there are no human activities in the room, and to open them as soon as the access door is opened. Also for this application, dimming screens automating systems that are silent, reliable and discrete are preferable.
the screen, particularly when it is a mosquito net, is place externally to the window and door frame. In this case, it would be desirable that, when the frame is closed, the mosquito net is open, in order to limit its aesthetically unpleasant view.

However, when the frame is opened, it is important to close the mosquito nets in order to avoid, especially in summer nights, the entry of insects. By manually driving the screen, it is however necessary to first open the window and then to lower the screen, or vice versa, first open the screen and then close the window, leaving thereby an interval of time in which both mosquito net and window and door frame are open, such interval being more than enough to allow the entry of mosquitoes. Due to an efficient mosquito net automating system, it would however be possible to avoid this, since the screen could be easily driven from inside. Moreover, if the automation system could be able to guarantee a high mosquito net operating quickness and a high level of intrinsic safety, it would be possible to drive the mosquito net directly from the window actuation, guaranteeing its perfect closure before the window is really opened, making its use even easier and more efficient.

In the art, a roller screen is currently in a box placed in an upper position with respect to the opening to be protected, containing a generally metallic pipe, on which a textile screen is wound. Laterally, on the opening sides, two generally metallic guides are present, that allow the screen dragged by its handle bar to correctly descend and remain in the correct position.

A further object of the guides is preventing light, through suitable gaskets, or even simply a labyrinth path, from laterally leaking in case of a sun screen, and insects, in case of a mosquito net, from passing on the net sides. In the winding pipe a torsion spring is further contained, with the purpose of balancing or even rewinding the textile cloth.

The problem of automating dimming and mosquito net screens is currently solved by electric motoring them. In particular in standard systems, the motor is contained in the above pipe, with evident size limits, and the cloth descends by being only subjected to the typically scarce induced tension of the handle bar weight. This configuration has to comply with two different problems, and in any case high installation costs (100 Euro minimum only for the motor of an automating system for a window roller screen).

The first one of these problems occurs when, as customarily occurs, the presence of an electric motor in the screen winding pipe has to be hidden. In this case, the available space is too small to install a motor of the necessary power and reliability, this consequently constraining the motor sizes generating a slow and noisy operation due to high reduction ratios necessary for applying them, with scarce reliability due to the fact that the motor must necessarily work at extremely high speeds (even 20,000 rpm), with unavoidable breakage in case of malfunction of screen limit switches due to the impossibility of realising an efficient torque limiting device with such high reduction ratios.

The second problem is substantially aesthetic since, when system functionality has to be improved by using an external motor, and thereby with the chance of being adequately size it, and above all in case of window screens, the visual result that is obtained is extremely problematic.

In all known cases, however, being the screen let drop from its own winding roller without any other tensioning apart from its own weight and its own handle bar, the screen remains stretched and tends to easily go out of its own guides, particularly in case of wind. Moreover, in the existing systems, the handle bar freely slides in the guides, compensating for possible distortions of window and door frame only through a high clearance inside the guides themselves, consequently generating a scarce screen movement quality.

There are automating systems that can guarantee a quick screen movement, but they are, such as for example in case of a linear axis driven by brush-less motors, products with a mostly industrial arrangement, characterised by high installation costs, and that, therefore, scarcely comply with the need of an automating system that is available on a large scale.

In all cases, however, no existing automating system guarantees quickness, reliability, cheapness and operating safety that are enough for being able to satisfy one of the previously described cases. Object of the present invention is solving the above prior art problems by providing an automating system for mobile screens, in particular dimming, sun and mosquito net screens that are able to slide and able to be wound, that allows a quick, safe and reliable handling of the screens and that, at the same time, can be more cheaply manufactured.

The above and other objects and advantages of the invention, as will appear from the following description, are obtained by am automating system for mobile screens as claimed in claim 1. Preferred embodiments and non-trivial variations of the present invention are claimed in the dependent Claims.

The present invention will be better described by some preferred embodiments thereof, given as a non-limiting example, with reference to the enclosed drawings, in which:

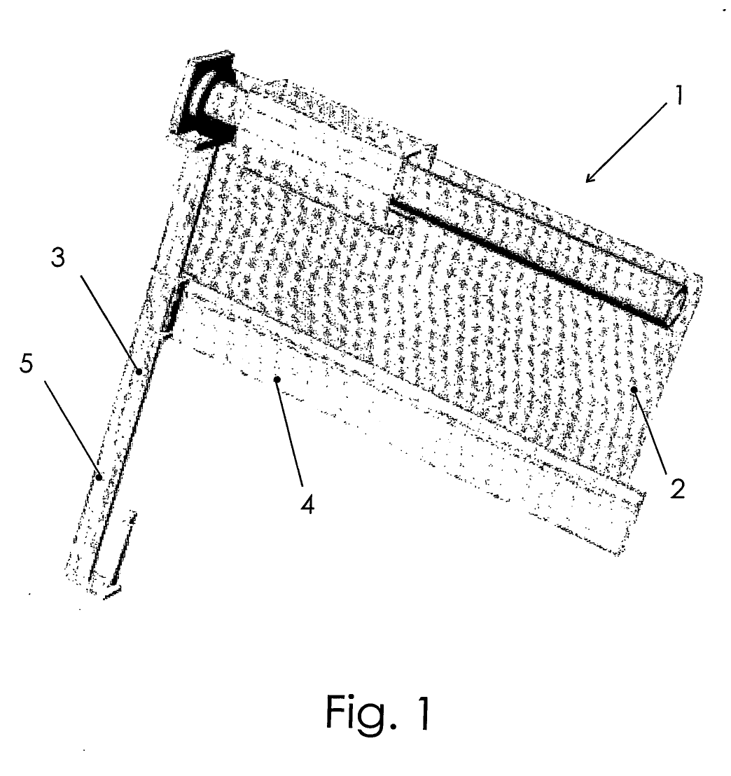

FIG. 1 shows a perspective view of an embodiment of the automating system for mobile screens according to the present invention; and

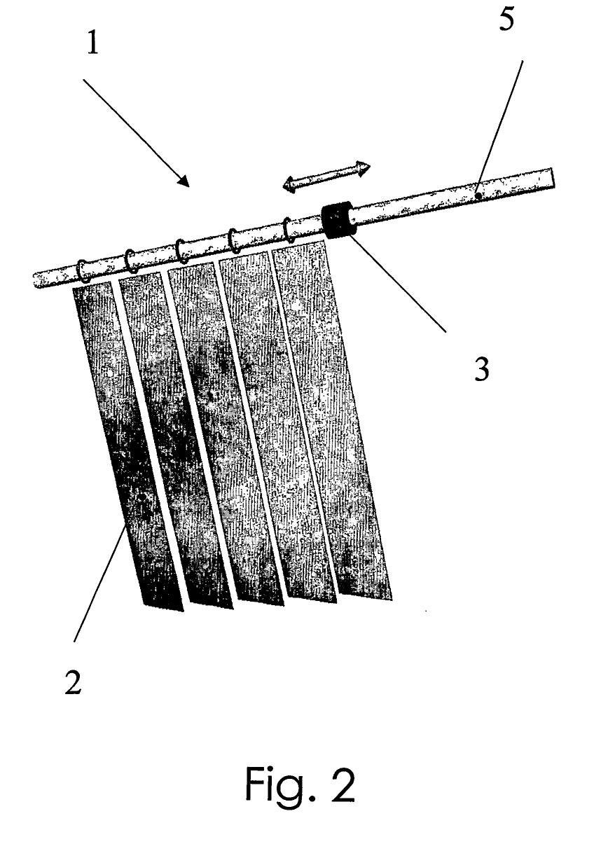

FIG. 2 shows a perspective view of another embodiment of the automating system for mobile screens according to the present invention.

With reference to the Figures, the automating system for mobile screens 1 according to the present invention is composed of:
at least one mobile screen 2;
movement guiding means for the mobile screen 2;
compressing means for a fluid;
channelling means for the fluid;
at least one magnetic element inside the guiding means; and
at least one magnetic element 3 outside the guiding means.

As previously stated, the system 1 provides that the mobile screen 2 can be, without limits, a dimming screen, a sun screen, a thermal screen, a curtain or a mosquito net, both of the slidable and of the windable types.

In FIG. 1, as a non-limiting example, the system 1 has been applied to a vertically-moving type of screen 2. In case the vertically-moving screen 2 is not, for example, a rigid panel, the system 1 will also comprise an handle bar 4. In particular, FIG. 1 shows an application of the system 1 to a roller screen 2.

In this preferred embodiment, the above movement guiding means of the mobile screen 2 are two tubes 5 with thin wall of a paramagnetic material (plastic materials, aluminium, austenitic stainless steel, etc.), each one typically arranged in parallel with an opening riser, inside each one of which at least one internal high-induction magnetic element slides. The external magnetic elements 3, composing an external magnetic system, with generally toroidal shape, are adapted to be constrained, if the mobile screen 2 is a rigid panel, to the opposite ends of one side of such panel, otherwise to the ends of the handle bar 4, to which in turn at least one side of the mobile screen 2 is constrained, and for sliding outside the tubes 5. The external magnetic system is constrained to the rigid panel or the handle bar 4 of the screen 2 by means of a suitable holding means adapted to allow an adequate degree of translation freedom along the direction of the major axis of the handle bar 4, in addition to a complete freedom of angular movement around the three Euler angles. In this way a sliding system is realised for external magnetic elements 3 along the tubes 5, and consequently a moving system for the handle bar 4 in a direction that is parallel to the longitudinal axis of tubes 5, that is able to compensate for all possible window and door frame distortions and assembling errors, though moving in a desmodromic way along the tubes 5 that operate as guides.

This aspect is important, since the embodiment is facilitated for using preferably cylindrical tubes 5 since, both for this reason and for an easier realisation of the sealing gaskets, they are the most inexpensive and reliable solution.

FIG. 2 shows an application of the system 1 to a type of horizontally-moving screen 2 such as, for example, traditional, “venetian”, pleated or banded curtains. In this preferred embodiment, the above movement guiding means for the mobile screen 2 are a tube 5 with thin walls of a paramagnetic type, typically arranged parallel with an opening lintel, inside which at least one internal high-induction magnetic element slides.

Like in the previous preferred embodiment, the external magnetic elements 3 are of a generally toroidal shape, and in this embodiment they are adapted to be constrained at one end to the upper side of the screen 2 and to slide externally to the tube 5.

In all embodiments of the system 1, the internal and external magnetic elements 3 are associated with suitable devices made of ferromagnetic material, adapted to address their magnetic flows along the most adequate directions; this adequate addressing of flows allows the magnetic system generated by internal magnetic elements to be concatenated with a respective magnetic system generated by the external magnetic elements 3 to the tube 5. In this way a magnetic coupling is realised between internal magnetic elements and external magnetic elements, adapted to allow the transfer of dragging forces along the direction of tube 5 axis.

The maximum force that can be transferred depends on the magnetic elements size, on their coercive force, on the configuration of flow-conveying ferromagnetic devices and on the air gap width crossed by the flow. In particular, it must be noted that the above air gap width is a project data that is translated into a physical system on which the user cannot intervene, thereby removing the danger of mishandling that could make the system dangerous.

Currently-existing permanent magnets, with which internal and external magnetic elements 3 have to be realised and that are able to generate a suitable magnetic system, are of three types:
samarium cobalt: they are rare earth magnets with a high Curie point (350° C.) but also a high cost; these magnets must be used in those applications in which the temperature is high, sacrificing the economic aspect to the functionality (for example screens for protecting laboratory muffle ovens, that by radiance could be overheated even to 300° C.);
neodymium iron boron of the high temperature type: they also are rare earth magnets, with medium Curie point (160° C.), and also a medium cost, adapted for applications in which the temperature could be high but not excessively high (for example protections for kitchen or restaurant ovens, in particular for fast food services, where the quick access to food heating ovens is important, and where for example the presence of a radiation-preventing screen in front of a infrared-microwave combined oven becomes mandatory);
neodymium iron boron of the low temperature type: they also are rare earth magnets, with a Curie point of about 80° C., that are very inexpensive and suitable for all applications in which temperatures are normal (screens for window and doors frames, etc.).

The internal magnetic system, generated by internal magnetic elements, is moved through an adequate pressurisation of a first and a second chamber defined by the upper and lower part of each tube 5 and divided by their own internal magnetic elements. The above fluid compressing means are represented, here as a non-limiting example, by an air compressor. Such pressurised air is suitably conveyed inside the above first and second chambers by a system with valves and ducts, composing the above fluid conveying and controlling means, according to the movements that has to be given to the screen 2.

In the preferred but not limiting embodiment shown in FIG. 1, the above fist chambers, as well as the second chambers of the two tubes 5 are mutually connected by at least one duct; this configuration allows, together with the differential effect induced by the possible presence of the handle bar 4 that tends to balance the traction forces of the screen 2, synchronising the movement speed of the magnetic systems on both tubes 5 thereby allowing the screen 2 to always move in parallel with itself; moreover, each one of these two ducts ends with a pneumatic valve of the 5-2 type (if an always complete “all up”, “all down” movement is desired), or of the closed centres 5-3 type (if the screen has to be able to be stopped in any position).

The above mentioned configurations of the channelling and controlling systems are a non-limiting example since, for example, more complex valve systems can be realised, aimed to perform different functionalities in a pneumatic logic, for example with a collective drive.

In the preferred embodiments of the present invention, the valve exhaust is adjusted by a single pin valve and with a single silencer, in order to perform the same operating speeds along the two directions, but nothing prevents from adjusting the exhausts independently if a different speed is desired when opening and closing the screen 2. Further pneumatic operating details are known in the art and therefore they will not be dealt with in detail.

Each internal magnetic system is equipped with at least one gasket adapted to seal the sliding of internal magnetic elements inside the tube 5.

The internal magnetic system is further equipped with two suitable appendixes, adapted to partially obstruct air from going out from the counter-pressurised chamber, shortly before the mechanical contact occurs between external magnetic elements and limit switch. In such a way a further counter-pressure is generated that slows down the screen 2 stroke by dampening its impact with the limit switch. Finally, the system 1 according to the present invention allows automating the movement of mobile screens 2, allowing to obtain the following advantages;
reduced material cost for every single automation (few Euro);
motor with always adequate sizes since placed not near the window and door frame;
reduced motor cost (few tenth of Euro) and anyway single, since a single motor drives multiple drives;
in applications where a source of compressed air is already present, the motor is not necessary;
high movement speed (it can be adjusted from few cm/s to at least 1 m/s);
absence of limit switch mechanisms, thereby with the advantage of avoiding the need of adjusting the stroke and the risk of breakage;
gradual and automatic intrinsic stop dampening;
intrinsic product safety, since the force transmitted to the handle bar 4 or the rigid panel can be defined with accuracy by the magnetic coupling intensity between internal and external magnetic elements 3;
in case of strong wind, it can be provided that, upon increasing the effort onto the dragging mechanism, this gets freed generating the complete opening of the screen 2, that in this way is arranged in a protection position;
in case of uncoupling between internal and external magnetic systems, automatic re-coupling of the two systems at the first performed drive, without other interventions by a user;
it is possible to stop the screen 2 in any position;
it is possible to drive multiple screen 2 simultaneously from a centralised position;
average lifetime of the system 1, in number of cycles, that is tenths of times longer than the one of traditional motored systems;
insensitivity to the fatigue caused by drives with high cadence (contrary to standard motoring that are overheated);
it is possible, given the presence of compressed air coupled with the movement, to carry out a cleaning cycle of the screen 2, by blowing the cloth with an air blade while it is made slide in front of it, particularly useful when the screen is aimed for external applications in environments that are dusty or full of smog, in which obviously the efficacy of a cleaning without damaging the cloth is as higher as the cleaning cycles are light and frequent; if then the device is connected to a smart system and to a position sensor, it is possible from time to time to only treat the part that remained exposed to the last cycle;
intrinsic reliability with respect to possible breakage due to movement forcing by a user;
absolute electric safety, above all in case of external assembling to adverse atmospheric agents, due to the absence of electric current inside the system 1 itself.

Moreover, when coupled with a position and/or a presence and/or a brightness sensor, the system 1 allows:
adjusting the screen 2 position locally or remotely from a centralised intelligence depending on;
programmed room brightness;
presence or absence of personnel inside the room (in particular for energy saving);
adjusting at the same height all screens 2 for the whole facade of a building, with consequent smooth internal lighting adjustment with undoubted aesthetic advantages for the facade;
introducing a smart system that, taking into account different factors, optimises system 1 performance, particularly for energy savings. As a non-limiting example, one of the possible applications for such purpose provides that the system 1, taking into account the various above-mentioned sensors (but possible also other ones that have not been mentioned, that anyway can be interfaced with the system), optimises the energy saving for winter heating by assigning a priority to the screen 2 opening at a value set by the user in case of human presence in the room and, in case of absence, arranges for the complete opening of the screen 2 if such a sun radiance occurs as to make the greenhouse effect, caused by the frame glass, exploitation convenient, while it places the screen 2 in a complete closure in the opposite case; due to the position sensor, it is further possible to avoid the all-closed condition if plants or animals are present in the room and would suffer from this: in such case it is possible to set a partial closure position of the screen 2 to a value that can be set by the user.

1. An automating system for mobile screens, comprising:
at least one mobile screen;
movement guiding means for said mobile screen;
compressing means for a fluid, said fluid providing a moving thrust of said mobile screen;
channeling and controlling means for said fluid;
internal magnetic elements placed inside said guiding means; and
external magnetic elements * placed outside said guiding means, and connected to said mobile screen and cooperating with said internal magnetic elements for moving said screen.

2. A system according to claim 1, comprising a handle bar.

3. A system according to claim 1, wherein said at least one mobile screen is able to slide.

4. A system according to claim 1, wherein said at least one mobile screen is able to be wound.

5. A system according to claim 1, wherein said at least one mobile screen can be collected as a package.

6. A system according to claim 1, said at least one mobile screen is a dimming screen or a sun screen or a thermal screen or a curtain or a mosquito net.

7. A system according to claim 1, wherein said guiding means are at least one tube said tube being made of a paramagnetic material.

8. A system according to claim 7, wherein said at least one tube contains at least one of said internal magnetic elements.

9. A system according to claim 7, wherein said internal magnetic elements are adapted to slide internally to said tube.

10. A system according to claim 7, wherein said external magnetic elements are adapted to slide on an external surface of said tube.

11. A system according to claim 7, wherein said tube has at least one of said external magnetic elements that slides onto said external surface.

12. A system according to claim 1, wherein at least one end of one side of said mobile screen is constrained to at least one of said external magnetic elements.

13. A system according to claim 2, wherein said at least one side of said mobile screen is constrained to said handle bar.

14. A system according to claim 2, wherein each one of two opposite ends of said handle bar is constrained to at least one of said external magnetic elements.

15. A system according to claim 1, wherein said internal magnetic elements are equipped with a first device made of ferromagnetic material adapted to address the magnetic flows generated by said internal magnetic elements.

16. A system according to claim 15, wherein said external magnetic elements are equipped with a second device made of ferromagnetic material adapted to address the magnetic flows generated by said external magnetic elements.

17. A system according to claim 16, wherein said first and second device made of ferromagnetic material are adapted to allow concatenating said magnetic flows generated by said internal magnetic element and said magnetic flows generated by said external magnetic element.

18. A system according to claim 7, wherein said tube is divided into a first chamber and a second chamber by said at least one internal magnetic element.

19. A system according to claim 1, wherein said channeling and controlling means comprise a plurality of ducts, a plurality of valves and a plurality of holding means of said fluid.

20. A system according to claim 18, wherein said fluid compressing means and said fluid channeling and controlling means are adapted to generate a pressure differential between said first chamber and said second chamber.

21. A system according to claim 7, further comprising a position sensor adapted to determine a position of said screen with respect to said at least one tube.

22. A system according to claim 1, further comprising a diffuser of said fluid adapted to address a flow of said fluid towards a surface of said mobile screen.

23. A system according to claim 1, wherein said fluid is a gas, air or a liquid.
